(19) United States
(12) Patent Application Publication
(10) Pub. No.: US 2006/0073058 A1
(43) Pub. Date: Apr. 6, 2006

(54) Orbiting vane compressor with side-inlet structure

(75) Inventors: Seon-woong Hwang, Anyang-si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/111,881

(22) Filed: Apr. 22, 2005

(30) Foreign Application Priority Data
Oct. 6, 2004 (KR) 10-2004-0079613

(51) Int. Cl. F01C 20/18; F16N 13/20; F04C 2/00; F01C 1/02; F03C 4/00

(52) U.S. Cl. 418/59; 418/62; 418/30

(57) ABSTRACT

Disclosed herein is an orbiting vane compressor with a side-inlet structure that is capable of compressing air in a cylinder according to an orbiting movement of an orbiting vane, the orbiting vane compressor being applied to a refrigerant compressor having refrigerant gas inlet and outlet channels isolated from each other, thereby increasing the sectional area of the refrigerant gas inlet channel. Refrigerant gas is introduced into the cylinder from the side of the cylinder, is compressed in the cylinder, and is then discharged upward or downward out of the cylinder. As a result, refrigerant gas introduced into the cylinder through the refrigerant gas inlet channel is prevented from being heated by compressed refrigerant gas discharged through the refrigerant gas outlet channel.

### BACKGROUND OF THE INVENTION

1. Field of the Invention

The present invention relates to an orbiting vane compressor, and, more particularly, to an orbiting vane compressor with a side-inlet structure that is capable of compressing air in a cylinder according to an orbiting movement of an orbiting vane while refrigerant gas inlet and outlet channels are isolated from each other and of increasing the sectional area of the refrigerant gas inlet channel.

2. Description of the Related Art

Generally, a vane compressor compresses air introduced into a cylinder according to an orbiting movement of a vane. FIG. 1 is a longitudinal sectional view illustrating the structure of a conventional vane compressor.

As shown in FIG. 1, the vane compressor comprises a compression unit 100 connected to a drive unit (not shown) via a rotary shaft 120. The compression unit 100 is hermetically sealed by upper and lower housings 110 and 110a. In the compression unit 100 is disposed an orbiting vane 140, which is attached to an eccentric part 120a of the rotary shaft 120 for performing an orbiting movement in the upper part of a cylinder 130 when the rotary shaft 120 is rotated.

The cylinder 130 is provided at the upper part thereof with a cylinder cover 131 having inner and outer outlet holes 131a and 131b. In the cylinder 130 is formed an inner ring 132. Between the inner ring 132 and the inner wall of the cylinder is defined an annular space 133. The orbiting vane 140 is provided at the upper part thereof with a circular vane 140a, which performs an orbiting movement in the annular space 133 of the cylinder 130. As a result, compression chambers are formed in the annular space 133 at the inside and the outside of the circular vane 140a.

The cylinder cover 131 is provided with an inlet hole 134 for allowing external air to be introduced into the cylinder 130. The inlet hole 134 is connected to an inlet tube 150, which vertically penetrates the upper housing 110. At a predetermined position of the circumferential part of the upper housing 110 is formed an outlet tube 160.

In the conventional vane compressor with the above-stated construction, external air is introduced into the cylinder 130 through the inlet tube 150 and the inlet hole 134. The air introduced into the cylinder 130 is compressed by the orbiting vane 140, which performs an orbiting movement in the cylinder 130 by power transmitted to the orbiting vane 140 from the drive unit via the rotary shaft 120. The compressed air is guided into the upper housing 110 through the inner and outer outlet holes 131a and 131b of the cylinder 130, and is then discharged out of the vane compressor through the outlet tube 160 of the upper housing 110.

It is impossible, however, to apply the conventional vane compressor with the above-stated construction and operation as a refrigerant compressor used in a refrigerator or an air conditioner.

More specifically, there is a negligible difference between the temperature of air before being compressed and the temperature of air after being compressed while there is a significant difference between the temperature of refrigerant gas before being compressed and the temperature of refrigerant gas after being compressed. Consequently, if a refrigerant gas outlet channel, through which compressed refrigerant gas having high temperature and high pressure is discharged, is disposed adjacent to a refrigerant gas inlet channel through which low-temperature and low-pressure refrigerant gas is introduced, the temperature of the introduced refrigerant gas is increased, and therefore, compression efficiency of the vane compressor is lowered. For this reason, it is necessary to isolate the refrigerant gas inlet channel and the refrigerant gas outlet channel from each other.

In the conventional vane compressor, however, the inlet tube 150 extends through the inner space of the upper housing 110, into which compressed air is discharged. Consequently, when the conventional vane compressor is applied as a refrigerant compressor, low-temperature and low-pressure refrigerant gas introduced into the cylinder 130 through the inlet tube 150 is heated by high-temperature and high-pressure refrigerant gas, which has been compressed and discharged into the upper housing 110. As a result, the refrigerant gas is introduced into the cylinder in a high-temperature and low-pressure state, which decreases the volumetric efficiency of the compressor. Consequently, the compression performance of the compressor is deteriorated.

It can be seen from the above description that the refrigerant gas inlet channel and the refrigerant gas outlet channel must be isolated from each other without interference therebetween in order to ensure that the vane compressor performs the compression operation according to the orbiting movement of a vane as a refrigerant compressor.

When the inlet hole 134 is disposed above the circular vane 140a as described above, the sectional area of the refrigerant gas inlet channel, including the inlet tube 150 and the inlet hole 134, is limited to the radius of the compression chamber of the cylinder, i.e., the annular space 133 of the cylinder, which is relatively less than the height of the circular vane 140a. Consequently, it is impossible to increase the sectional area of the refrigerant gas inlet channel, which is necessary to reduce pressure loss.

When the inner and outer outlet holes 131a and 131b formed at the cylinder cover 131 are disposed adjacent to the outlet tube 160 of the upper housing 110, oil may be excessively discharged through the outlet tube 160.

### SUMMARY OF THE INVENTION

Therefore, the present invention has been made in view of the above problems, and it is an object of the present invention to provide an orbiting vane compressor with a side-inlet structure that is capable of compressing air in a cylinder according to an orbiting movement of an orbiting vane, the orbiting vane compressor being applied to a refrigerant compressor.

It is another object of the present invention to provide an orbiting vane compressor having refrigerant gas inlet and outlet channels isolated from each other, thereby increasing the sectional area of the refrigerant gas inlet outlet channel.

In accordance with the present invention, the above and other objects can be accomplished by the provision of an orbiting vane compressor having a side-inlet structure comprising: a crankshaft disposed in a hermetically sealed shell such that the crankshaft can be rotated by a drive unit; and a compression unit for compressing refrigerant gas introduced into a cylinder according to an orbiting movement of an orbiting vane, which is attached to the crankshaft, in an annular space defined in the cylinder, wherein the cylinder is provided at a predetermined position of the circumferential part thereof with a side inlet port such that refrigerant gas is introduced into the cylinder through the side inlet port, is compressed in the cylinder, and is then discharged upward or downward out of the cylinder.

Preferably, the orbiting vane comprises: a circular vane formed at one side of a vane plate; and a boss formed at the other side of the vane plate.

Preferably, the boss is formed at the side of the vane plate inside the circular vane while being protruded outward.

Preferably, the circular vane is provided at a predetermined position of the circumferential part thereof with an opening, and the orbiting vane further comprises: a slider disposed in the opening.

Preferably, the circular vane is provided at another predetermined position of the circumferential part thereof, adjacent to the position where the slider is disposed, with a through-hole for allowing refrigerant gas to be introduced into the circular vane therethrough.

Preferably, the through-hole is opened to the upper part of the circular vane and to the slider of the circular vane.

Preferably, the through-hole is opened to the slider of the circular vane.

Preferably, the through-hole is isolated from the slider, and the through-hole comprises at least one polygonal through-hole part.

Preferably, the through-hole is isolated from the slider, and the through-hole comprises at least one circular through-hole part.

Preferably, the annular space of the cylinder is defined between an inner ring disposed in the cylinder and the inner wall of the cylinder.

Preferably, the annular space of the cylinder is divided into inner and outer compression chambers by the circular vane.

Preferably, the cylinder is provided at the upper or lower part thereof with a pair of inner and outer outlet ports, which communicate with the inner and outer compression chambers, respectively.

Preferably, the orbiting vane compressor further comprises: a muffler disposed below a lower flange such that the muffler surrounds the outlet port provided at the lower part of the cylinder; and a refrigerant gas outlet channel for guiding high-pressure refrigerant gas discharged from the outlet port of the cylinder into the shell.

Preferably, the refrigerant gas outlet channel extends upward from muffler through the cylinder.

Preferably, refrigerant gas discharged into the shell from the outlet port provided at the upper part of the cylinder is discharged through an outlet tube penetrating the shell below an inlet tube.

Preferably, the orbiting vane compressor further comprises: a separating plate disposed between the outer circumferential part of the cylinder and the inner circumferential part of the shell such that refrigerant gas discharged through the outlet port provided at the upper part of the cylinder is guided into the outlet tube through the high-pressure chamber disposed above the cylinder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the structure of a conventional vane compressor;

FIG. 2 is a longitudinal sectional view illustrating the overall structure of an orbiting vane compressor according to a first preferred embodiment of the present invention;

FIG. 3 is an exploded perspective view illustrating a compression unit according to a first preferred embodiment of the present invention;

FIG. 4 is a cross-sectional view illustrating the operation of the compression unit according to the first preferred embodiment of the present invention shown in FIG. 3;

FIG. 5 is an exploded perspective view illustrating an orbiting vane of a compression unit according to a second preferred embodiment of the present invention;

FIG. 6 is an exploded perspective view illustrating an orbiting vane of a compression unit according to a third preferred embodiment of the present invention;

FIG. 7 is a longitudinal sectional view illustrating the overall structure of an orbiting vane compressor according to a second preferred embodiment of the present invention;

FIG. 8 is a longitudinal sectional view illustrating the overall structure of an orbiting vane compressor according to a third preferred embodiment of the present invention;

FIG. 9 is a longitudinal sectional view illustrating the overall structure of an orbiting vane compressor according to a fourth preferred embodiment of the present invention; and

FIG. 10 is a longitudinal sectional view illustrating the overall structure of an orbiting vane compressor according to a fifth preferred embodiment of the present invention.

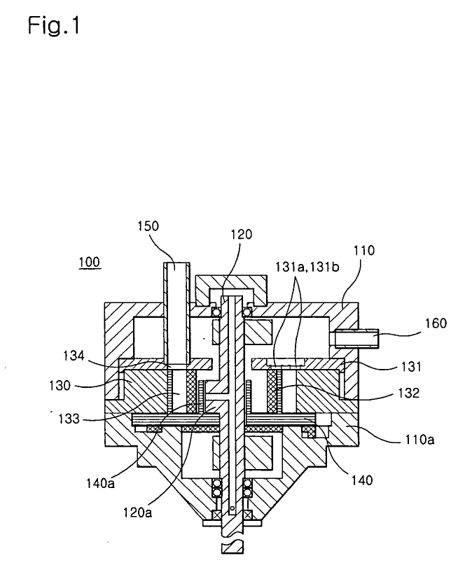

### DESCRIPTION OF THE PREFERRED EMBODIMENTS

Now, preferred embodiments of the present invention will be described in detail with reference to the accompanying drawings.

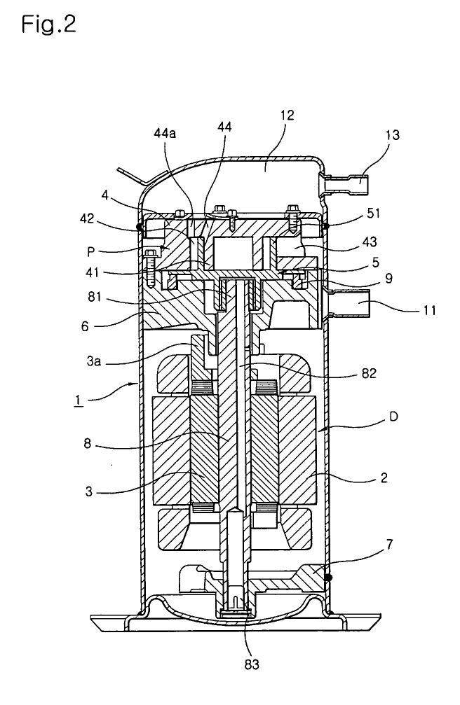

FIG. 2 is a longitudinal sectional view illustrating the overall structure of an orbiting vane compressor according to a first preferred embodiment of the present invention.

The orbiting vane compressor shown in FIG. 2 is a low-pressure type refrigerant compressor. As shown in FIG. 2, a drive unit D and a compression unit P are mounted in a shell 1 while the drive unit D and the compression unit P are hermetically sealed. The drive unit D and the compression unit P are connected to each other via a vertical crankshaft 8, the upper and lower ends of which are rotatably supported by a main frame 6 and a subsidiary frame 7, such that power from the drive unit D is transmitted to the compression unit P through the crankshaft 8.

The drive unit D comprises: a stator 2 fixedly disposed between the main frame 6 and the subsidiary frame 7; and a rotor 3 disposed in the stator 2 for rotating the crankshaft 8, which vertically extends through the rotor 3, when electric current is supplied to the rotor 3. The rotor 3 is provided at the top and bottom parts thereof with balance weights 3a, which are disposed symmetrically to each other for preventing the crankshaft 8 from being rotated in an unbalanced state due to a crank pin 81.

The compression unit P comprises an orbiting vane 5, the lower part of which is attached to the crank pin 81. As the orbiting vane 5 performs an orbiting movement in a cylinder 4, refrigerant gas introduced into the cylinder 4 is compressed. The cylinder 4 comprises an inner ring 41 integrally formed at the upper part thereof while being protruded downward. The orbiting vane 5 comprises a circular vane 51 formed at the upper part thereof while being protruded upward. The circular vane 51 performs an orbiting movement in an annular space 42 defined between the inner ring 41 and the inner wall of the cylinder 4. Through the orbiting movement of the circular vane 51, inner and outer compression chambers are formed at the inside and the outside of the circular vane 51, respectively. Refrigerant gases compressed in the inner and outer compression chambers are discharged out of the cylinder 4 through inner and outer outlet ports 44 and 44a formed at the upper part of the cylinder 4, respectively.

Between the main frame 6 and the orbiting vane 5 is disposed an Oldham's ring 9 for preventing rotation of the orbiting vane 5. Through the crankshaft 8 is longitudinally formed an oil supplying channel 82 for allowing oil to be supplied to the compression unit P therethrough when an oil pump 83 mounted at the lower end of the crankshaft 8 is operated.

Unexplained reference numeral 11 indicates an inlet tube, 12 a high-pressure chamber, and 13 an outlet tube.

The orbiting vane compressor according to the illustrated embodiment of the present invention is characterized in that refrigerant gas introduced into the shell through the inlet tube 11 is guided into the cylinder 4 from the side of the cylinder, is compressed through an orbiting movement of the orbiting vane 5, and is then discharged into the high-pressure chamber 12 formed above the cylinder 4.

To this end, the cylinder is provided at one side thereof, specifically, at a predetermined position of the circumferential part thereof, with an inlet port 43, and the inner and outer outlet ports 44 and 44a are formed at predetermined positions of the upper part of the cylinder 4, respectively, such that the inner and outer outlet ports 44 and 44a communicates with the annular space 42 defined in the cylinder 4.

When electric current is supplied to the drive unit D, the rotor 3 of the drive unit D is rotated, and therefore, the crankshaft 8 is also rotated. As the crankshaft 8 is rotated, the orbiting vane 5 of the compression unit P performs an orbiting movement along a radius of the orbiting movement while the crank pin 81 of the crankshaft 8 is fitted in a boss 55 formed at the lower part of the orbiting vane 5.

As a result, the circular vane 51 of the orbiting vane 5, which is inserted in the annular space 42 defined between the inner ring 41 and the inner wall of the cylinder 4, also performs an orbiting movement to compress refrigerant gas introduced into the annular space 42 through the inlet port 43 of the cylinder 4. At this time, the inner and outer compression chambers are formed at the inside and the outside of the circular vane 51 in the annular space 41, respectively. Refrigerant gases compressed in the inner and outer compression chambers are guided to the high-pressure chamber 12, which is formed at the upper part of the shell 1, through the inner and outer outlet ports 44 and 44a of the cylinder 4, which communicate with the inner and outer compression chambers, respectively, and are then discharged out of the orbiting vane compressor through the outlet tube 13. In this way, high-temperature and high-pressure refrigerant gas is discharged.

As described above, the inlet port 43 is formed at the side part of the cylinder 4, especially, at the circumferential part of the cylinder 4 such that refrigerant gas is introduced into the cylinder 4 from the side of the cylinder through the inlet port 43. Consequently, a refrigerant gas inlet channel and a refrigerant gas outlet channel are isolated from each other, and therefore, low-temperature and low-pressure refrigerant gas introduced into the cylinder through the refrigerant gas inlet channel is prevented from being heated by compressed refrigerant gas, having high temperature and high pressure, discharged through the refrigerant gas outlet channel.

Since the inlet port 43 is formed at the side part of the cylinder 4, especially, at the circumferential part of the cylinder 4 in accordance with the present invention, the sectional area of the refrigerant gas inlet channel is increased without being limited to the radius of the compression chamber of the cylinder 4, i.e., the annular space 42 of the cylinder 4, and therefore, pressure loss is minimized.

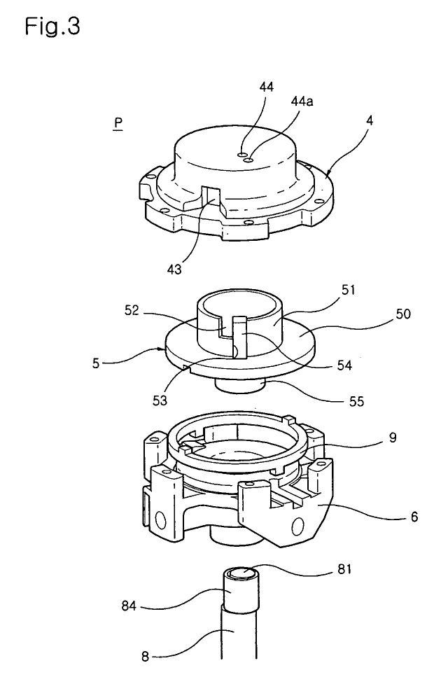

FIG. 3 is an exploded perspective view illustrating a compression unit P according to a first preferred embodiment of the present invention.

In the compression unit P, as shown in FIG. 2, the orbiting vane 5, which is connected to the crankshaft 8, is disposed on the upper end of the main frame 6, which rotatably supports the upper part of the crankshaft 8. The cylinder 4, which is attached to the main frame 6, is disposed above the orbiting vane 5. The inlet port 43 is formed at a predetermined position of the circumferential part of the cylinder 4. The inner and outer outlet ports 44 and 44a are formed at predetermined positions of the upper part of the cylinder 4.

At a predetermined position of the circumferential part of the circular vane 51 of the orbiting vane 5 is formed a through-hole 52 for allowing refrigerant gas introduced through the inlet port 43 of the cylinder 4 to be guided into the circular vane 51 therethrough. The through-hole 52 is opened to the upper part of the circular vane 51 and to a slider 54. The slider 54 is disposed in an opening 53, which is formed at another predetermined position of the circumferential part of the circular vane 51 of the orbiting vane 5 while being adjacent to the position where the through-hole 52 is formed, for maintaining the seal between low-pressure and high-pressure sides defined in the cylinder 4.

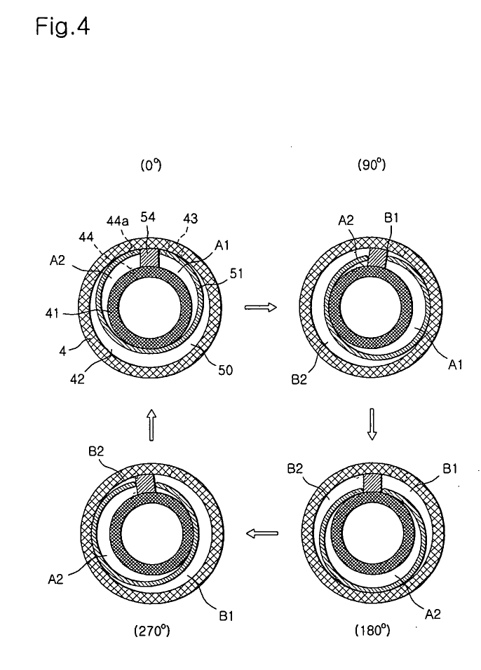

FIG. 4 is a cross-sectional view illustrating the operation of the compression unit according to the first preferred embodiment of the present invention shown in FIG. 3.

When the orbiting vane 5 of the compression unit P is driven by power transmitted to the compression unit P from the drive unit D through the crankshaft 8 (See FIG. 2), the circular vane 51 of the orbiting vane 5 disposed in the annular space 42 of the cylinder 4 performs an orbiting movement in the annular space 42 defined between the inner wall of the cylinder 4 and the inner ring 41, as indicated by arrows, to compress refrigerant gas introduced into the annular space 42 through the inlet port 43.

At the initial orbiting position of the orbiting vane 5 of the compression unit P (i.e., the O-degree orbiting position), refrigerant gas is introduced into an inner suction chamber A1 of the circular vane 51 through the inlet port 43 as the inlet port 43 communicates with the inner suction chamber A1, and compression is performed in an outer compression chamber B2 of the circular vane 51 while the outer compression chamber B2 does not communicate with the inlet port 43 and the outer outlet port 44a. Refrigerant gas is compressed in an inner compression chamber A2, and at the same time, the compressed refrigerant gas is discharged out of the inner compression chamber A2 through the inner outlet port 44.

At the 90-degree orbiting position of the orbiting vane 5 of the compression unit P, the compression is still performed in the outer compression chamber B2 of the circular vane 51, and almost all the compressed refrigerant gas is discharged out of the inner compression chamber A2 through the inner outlet port 44. At this stage, an outer suction chamber B1 appears so that refrigerant gas is introduced into the outer suction chamber B1 through the inlet port 43.

At the 180-degree orbiting position of the orbiting vane 5 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 44a. Consequently, compressed refrigerant gas is discharged out of the outer compression chamber B2 through the outer outlet port 44a.

At the 270-degree orbiting position of the orbiting vane 5 of the compression unit P, almost all the compressed refrigerant gas is discharged out of the outer compression chamber B2 of the circular vane 51 through the outer outlet port 44a, and the compression is still performed in the inner compression chamber A2 of the circular vane 51. Also, compression is newly performed in the outer suction chamber B1. When the orbiting vane 5 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the orbiting vane 5 of the compression unit P is returned to the position where the orbiting movement of the orbiting vane 5 is initiated. In this way, a 360-degree-per-cycle orbiting movement of the orbiting vane 5 of the compression unit P is accomplished. The orbiting movement of the orbiting vane 5 of the compression unit P is repeatedly performed in succession.

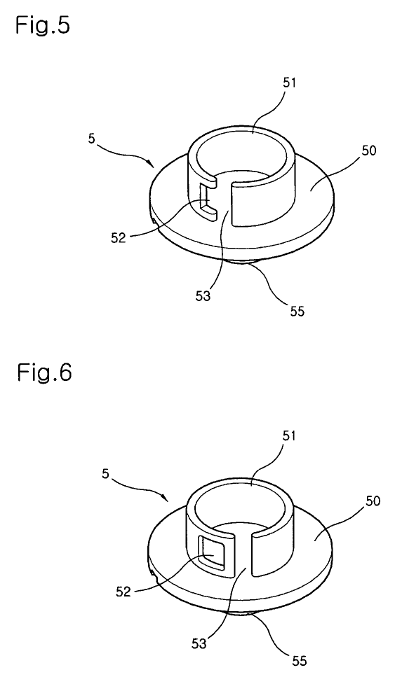

Meanwhile, the through-hole 52 formed at the circular vane 51 of the orbiting vane 5 may be configured such that the through-hole 52 is opened to the slider disposed in the opening 53, i.e., the through-hole 52 communicates with the opening 53, as shown in FIG. 5. Alternatively, the through-hole 52 formed at the circular vane 51 of the orbiting vane 5 may be configured such that the through-hole 52 is isolated from the slider disposed in the opening 53, i.e., the through-hole 52 does not communicate with the opening 53, as shown in FIG. 6.

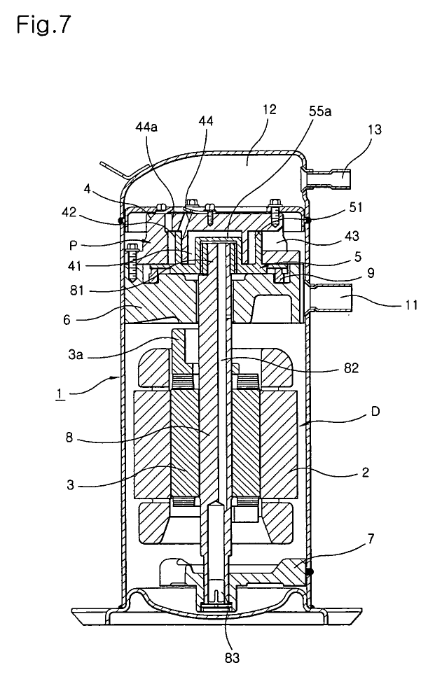

FIG. 7 is a longitudinal sectional view illustrating the overall structure of an orbiting vane compressor according to a second preferred embodiment of the present invention.

The orbiting vane compressor according to the second preferred embodiment of the present invention is a low-pressure type orbiting vane compressor like the orbiting vane compressor according to the previously described first preferred embodiment of the present invention. The orbiting vane compressor according to the second preferred embodiment of the present is identical in construction and operation to the orbiting vane compressor according to the first preferred embodiment of the present except that the orbiting vane 5 has a top boss 55a formed at the upper part of the vane plate 50 while being protruded upward, and the crank pin 81 of the crankshaft 8 is fitted in the top boss 55a of the orbiting vane 5. For example, the inlet port 43 is formed at a predetermined position of the circumferential part of the cylinder 4, as in the orbiting vane compressor according to the first preferred embodiment of the present. Accordingly, a detailed description of the other components of the orbiting vane compressor according to the second preferred embodiment of the present will not be given.

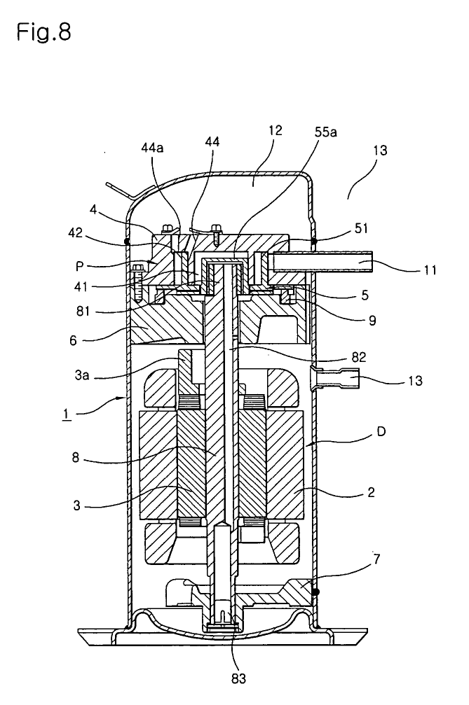

FIG. 8 is a longitudinal sectional view illustrating the overall structure of an orbiting vane compressor according to a third preferred embodiment of the present invention.

The orbiting vane compressor according to the third preferred embodiment of the present invention is a high-pressure type orbiting vane compressor. The orbiting vane compressor according to the third preferred embodiment of the present is identical in construction and operation to the orbiting vane compressor according to any one of the first and second preferred embodiments of the present invention except that the inlet tube 11, penetrating the shell 1, is connected in communication to the inlet port 43 formed at the circumferential part of the cylinder 4, and the outlet tube 13, also penetrating the shell, is disposed below the inlet tube 11. For example, the inlet port 43 is formed at a predetermined position of the circumferential part of the cylinder 4, as in the orbiting vane compressor according to any one of the first and second preferred embodiments of the present.

In the orbiting vane compressor according to the third preferred embodiment of the present invention, refrigerant gas is introduced into the cylinder 4 through the inlet tube 11 and the inlet port 43. The refrigerant gas introduced into the cylinder 4 is compressed by the orbiting vane 5 that performs an orbiting movement by power transmitted to the orbiting vane 5 from the drive unit D through the crankshaft 8, and is then guided into the shell 1 through the inner and outer outlet ports 44 and 44a of the cylinder 4. The compressed refrigerant gas, having high temperature and high pressure, in the shell 1 is discharged out of the orbiting vane compressor through the outlet tube 13.

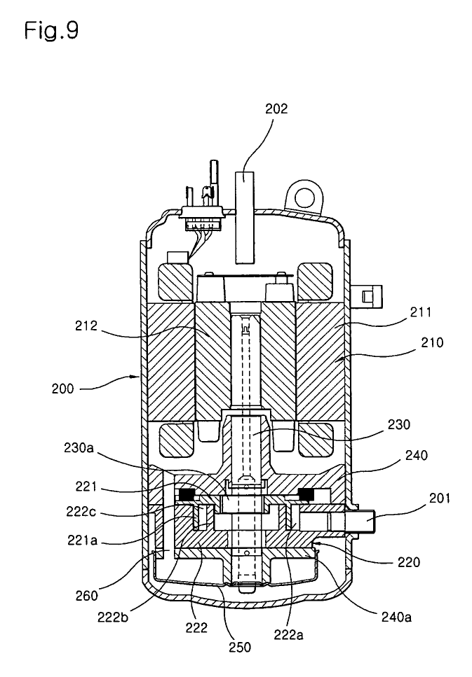

FIG. 9 is a longitudinal sectional view illustrating the overall structure of an orbiting vane compressor according to a fourth preferred embodiment of the present invention.

The orbiting vane compressor according to the fourth preferred embodiment of the present invention is a refrigerant compressor having an orbiting vane applied to the conventional rotary compressor. The orbiting vane compressor according to the fourth preferred embodiment of the present invention is characterized in that the orbiting vane compressor has two compression chambers while the conventional rotary compressor has only a single compression chamber.

As shown in FIG. 9, a drive unit 210 and a compression unit 220 are mounted in a shell 200 while the drive unit 210 and the compression unit 220 are hermetically sealed. The drive unit 210 is disposed in the upper inner part of the shell 200, and the compression unit 220 is disposed in the lower inner part of the shell 200. The drive unit 210 and the compression unit 220 are connected to each other via a vertical rotary shaft 230. The rotary shaft 230 has an eccentric part 230a.

The drive unit 210 comprises: a stator 211 fixedly disposed in the shell 200; and a rotor 212 disposed in the stator 211 for rotating the rotary shaft 230, which vertically extends through the rotor 212, when electric current is supplied to the rotor 212.

The compression unit 220 comprises an orbiting vane 221 attached to the eccentric part 230a of the rotary shaft 230. As the orbiting vane 221 performs an orbiting movement in a cylinder 222, refrigerant gas introduced into the cylinder 222 through an inlet port 222a formed at a predetermined position of the circumferential part of the cylinder 222 is compressed. The cylinder 222 comprises an inner ring 222b integrally formed at the lower part thereof while being protruded upward.

The orbiting vane 221 comprises a circular vane 221a formed at the lower part thereof while being protruded downward. The circular vane 221a performs an orbiting movement in an annular space 222c defined between the inner ring 222b and the inner wall of the cylinder 222. Through the orbiting movement of the circular vane 221a, inner and outer compression chambers are formed at the inside and the outside of the circular vane 221a, respectively. Refrigerant gases compressed in the inner and outer compression chambers are discharged out of the cylinder 222 through inner and outer outlet ports (not shown) formed at the lower part of the cylinder 222, respectively.

To the upper and lower parts of the cylinder 222 are attached upper and lower flanges 240 and 240a, respectively, by which the rotary shaft 230 is rotatably supported. Below the lower flange 240a is disposed a muffler 250, which communicates with a refrigerant gas outlet channel 260 vertically formed through one side of the compression unit 220. Compressed refrigerant gas discharged from the compression unit 220 is guided into the shell 200 through the muffler 250 and the refrigerant gas outlet channel 260.

Unexplained reference numeral 201 indicates an inlet tube, and 202 an outlet tube.

As described above, the inlet port 222a is formed at the side part of the cylinder 222, especially, at the circumferential part of the cylinder 222 such that refrigerant gas is introduced into the cylinder 222 from the side of the cylinder through the inlet port 222a. Consequently, the refrigerant gas inlet channel and the refrigerant gas outlet channel are isolated from each other, and therefore, low-temperature and low-pressure refrigerant gas introduced into the cylinder through the refrigerant gas inlet channel is prevented from being heated by compressed refrigerant gas, having high temperature and high pressure, discharged through the refrigerant gas outlet channel.

Since the inlet port 222a is formed at the side part of the cylinder 222, especially, at the circumferential part of the cylinder 222 in accordance with the present invention, the sectional area of the refrigerant gas inlet channel is increased without being limited to the radius of the compression chamber of the cylinder 222, i.e., the annular space 222b of the cylinder 222, and therefore, pressure loss is minimized.

The compressing operation of the orbiting vane compressor according to the fourth preferred embodiment of the present invention is identical to that of the orbiting vane compressor according to any one of the previous preferred embodiments of the present invention, and therefore, a detailed description of the compressing operation of the orbiting vane compressor according to the fourth preferred embodiment of the present invention will not be given.

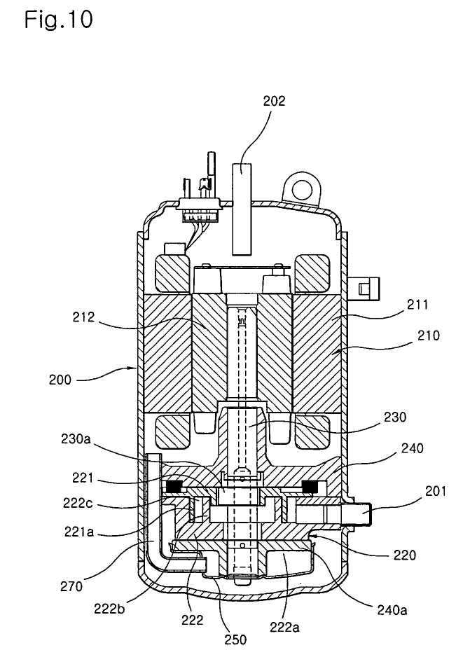

FIG. 10 is a longitudinal sectional view illustrating the overall structure of an orbiting vane compressor according to a fifth preferred embodiment of the present invention.

The orbiting vane compressor according to the fifth preferred embodiment of the present invention utilizes the same refrigerant compressor as the orbiting vane compressor according to the fourth preferred embodiment of the present invention, which is characterized in that the inlet port 222a is formed at a predetermined position of the circumferential part of the cylinder 222.

The orbiting vane compressor according to this embodiment of the present invention is identical in construction and operation to the orbiting vane compressor according to the fourth preferred embodiment of the present invention except that the orbiting vane compressor further comprises a refrigerant gas outlet pipe 270 having one end connected in communication to the muffler 250 and the other end communicating with the interior of the shell 200, the refrigerant gas outlet pipe 270 being disposed outside the compression unit 220 while the refrigerant gas outlet channel 260 is vertically formed through one side of the compression unit 220 in accordance with the fourth preferred embodiment of the present invention. Accordingly, a further detailed description of the orbiting vane compressor according to this embodiment will not be given.

As apparent from the above description, the orbiting vane compressor according to the present invention is constructed such that refrigerant gas is introduced into the cylinder from the side of the cylinder, is compressed in the cylinder, and is then discharged upward or downward out of the cylinder, i.e., the refrigerant gas inlet channel and the refrigerant gas outlet channel are isolated from each other. Consequently, the present invention has the effect of preventing low-temperature and low-pressure refrigerant gas introduced into the cylinder through the refrigerant gas inlet channel from being heated by compressed refrigerant gas, having high temperature and high pressure, discharged through the refrigerant gas outlet channel, and therefore, applying the orbiting vane compressor to a refrigerant compressor used in a refrigerator or an air conditioner.

Furthermore, the orbiting vane compressor according to the present invention is constructed such that refrigerant gas is introduced into the cylinder from the side of the cylinder, and therefore, the sectional area of the refrigerant gas inlet channel is increased without being limited to the radius of the compression chamber of the cylinder, i.e., the annular space of the cylinder. Consequently, the present invention has the effect of minimizing pressure loss.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An orbiting vane comprising:
a circular vane formed at one side of a vane plate;
the circular vane is provided at a predetermined position of the circumferential part thereof with an opening; and
a boss formed at the other side of the vane plate.

2. The vane as set forth in claim 1, wherein the boss is formed at the side of the vane plate inside the circular vane while being protruded outward.

3. The vane as set forth in claim 1, wherein
the orbiting vane further comprises: a slider disposed in the opening.

4. The vane as set forth in claim 3, wherein the circular vane is provided at another predetermined position of the circumferential part thereof, adjacent to the position where the slider is disposed, with a through-hole for allowing refrigerant gas to be introduced into the circular vane therethrough.

5. The vane as set forth in claim 4, wherein the through-hole is opened to the upper part of the circular vane and to the slider of the circular vane.

6. The vane as set forth in claim 4, wherein the through-hole is opened to the slider of the circular vane.

7. The vane as set forth in claim 4, wherein the through-hole is isolated from the slider, and the through-hole comprises at least one polygonal through-hole part.

8. The vane as set forth in claim 4, wherein the through-hole is isolated from the slider, and the through-hole comprises at least one circular through-hole part.

9. An orbiting vane compressor having a side-inlet structure comprising:
a crankshaft disposed in a hermetically sealed shell such that the crankshaft can be rotated by a drive unit; and
a compression unit for compressing refrigerant gas introduced into a cylinder according to an orbiting movement of an orbiting vane, which is mounted to the crankshaft, in an annular space defined in the cylinder, wherein
the cylinder is provided at a predetermined position of the circumferential part thereof with a side inlet port such that refrigerant gas is introduced into the cylinder through the side inlet port, is compressed in the cylinder, and is then discharged upward or downward out of the cylinder.

10. The compressor as set forth in claim 9, wherein the orbiting vane comprises:
a circular vane formed at one side of a vane plate; and
a boss formed at the other side of the vane plate.

11. The compressor as set forth in claim 10, wherein the boss is formed at the side of the vane plate inside the circular vane while being protruded outward.

12. The compressor as set forth in claim 10, wherein
the circular vane is provided at a predetermined position of the circumferential part thereof with an opening, and
the orbiting vane further comprises: a slider disposed in the opening.

13. The compressor as set forth in claim 12, wherein the circular vane is provided at another predetermined position of the circumferential part thereof, adjacent to the position where the slider is disposed, with a through-hole for allowing refrigerant gas to be introduced into the circular vane therethrough.

14. The compressor as set forth in claim 13, wherein the through-hole is opened to the upper part of the circular vane and to the slider of the circular vane.

15. The compressor as set forth in claim 13, wherein the through-hole is opened to the slider of the circular vane.

16. The compressor as set forth in claim 13, wherein the through-hole is isolated from the slider, and the through-hole comprises at least one polygonal through-hole part.

17. The compressor as set forth in claim 13, wherein the through-hole is isolated from the slider, and the through-hole comprises at least one circular through-hole part.

18. The compressor as set forth in claim 10, wherein the annular space of the cylinder is defined between an inner ring disposed in the cylinder and the inner wall of the cylinder.

19. The compressor as set forth in claim 18, wherein the annular space of the cylinder is divided into inner and outer compression chambers by the circular vane.

20. The compressor as set forth in claim 19, wherein the cylinder is provided at the upper or lower part thereof with a pair of inner and outer outlet ports, which communicate with the inner and outer compression chambers, respectively.

21. The compressor as set forth in claim 20, further comprising:
a muffler disposed below a lower flange such that the muffler surrounds the outlet port provided at the lower part of the cylinder; and
a refrigerant gas outlet channel for guiding high-pressure refrigerant gas discharged from the outlet port of the cylinder into the shell.

22. The compressor as set forth in claim 21, wherein the refrigerant gas outlet channel extends upward from muffler through the cylinder.

23. The compressor as set forth in claim 20, wherein refrigerant gas discharged into the shell from the outlet port provided at the upper part of the cylinder is discharged through an outlet tube penetrating the shell below an inlet tube.

24. The compressor as set forth in claim 20, further comprising:
a separating plate disposed between the outer circumferential part of the cylinder and the inner circumferential part of the shell such that refrigerant gas discharged through the outlet port provided at the upper part of the cylinder is guided into the outlet tube through the high-pressure chamber disposed above the cylinder.
